(19) United States
(12) Patent Application Publication
(10) Pub. No.: US 2009/0269239 A1
(43) Pub. Date: Oct. 29, 2009

(54) Process for Production of Aluminum Ingots, Aluminum Ingots, and Protective Gas for the Production of Aluminum Ingots

(75) Inventors: Yutaka Nagakura, Moka-shi (JP); Kenji Tokuda, Moka-shi (JP); Makoto Morishita, Moka-shi (JP); Hiroshi Sanui, Tokyo (JP); Yuji Nomura, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Taiyo Nippon Sanso Corporation, Shinagawa-ku, Tokyo (JP)

(21) Appl. No.: 12/158,263

(22) PCT Filed: Dec. 19, 2006
(86) PCT No.: PCT/JP2006/325301

§ 371 Date: Mar. 12, 2009

(30) Foreign Application Priority Data
Dec. 19, 2005 (JP) 2005-365040

(51) Int. Cl. C22C 21/06; B22D 25/06; C22C 21/00; C09K 3/00

(52) U.S. Cl. 420/542; 164/66.1; 420/528; 252/372

(57) ABSTRACT

To provide a method for producing an aluminum ingot whose oxides is reduced by preventing the surface of molten aluminum from being oxidized. The method according to the present invention includes a melting step (melting furnace 1) of melting an aluminum base metal into a molten aluminum or molten aluminum alloy; a holding step (holding furnace 2) of holding the resulting molten aluminum or molten aluminum alloy; a dehydrogenation step (dehydrogenation unit 3) of removing hydrogen gas from the molten aluminum or molten aluminum alloy; a filtration step (filter 4) of removing inclusions from the molten aluminum or molten aluminum alloy; and a casting step (casting device 5) of solidifying the molten aluminum or molten aluminum alloy into a predetermined shape, wherein at least one of the above steps is conducted in the atmosphere of a protective gas containing fluorinating gas, carbon dioxide gas, and nitrogen and/or argon gas.

### FIELD OF THE INVENTION

An aluminum or aluminum alloy ingot (hereinafter referred to as aluminum ingot) is produced by a melting step of melting an aluminum base metal into a molten aluminum; a holding step of holding the resulting molten aluminum; a dehydrogenation step of removing hydrogen gas from the molten aluminum; a filtration step of removing inclusions from the molten aluminum; and a casting step of pouring the molten aluminum into a water-cooled mold so that the molten aluminum is solidified into a predetermined shape.

In the production process (for example, the melting step and casting step) for producing the aluminum ingot from the aluminum base metal, the molten aluminum is heated to 700° C. or higher. Since aluminum is active metal, the molten aluminum will react with air to generate oxides.

Particularly, in a molten aluminum alloy containing magnesium (Mg), which is more active than aluminum, a large amount of oxides such as MgO, MgAl₂O₄ and the like will be generated and aggregated so as to form an aggregate (dross). Since the dross is a very hard rock-like material, it will take much time and labor to remove the dross. Further, if the dross is partially collapsed and mixed into the aluminum ingot, it will cause surface flaw and cracking of end-products (for example, aluminum sheet such as can material and disc material) manufactured from such an aluminum ingot.

In order to prevent the surface flaw and cracking of the end-product and ensure the predetermined performance of the end-product, a plurality of oxides removing processes are performed between the melting step and the casting step, such processes including an in-furnace refining process, an in-line refining process and a filtering process (performed immediately before the casting step). Particularly, since the filtering process can remove even very fine oxides having a size of approximately 10 μm, the quality of the aluminum alloy can be ensured, which means the quality of the end-product can be ensured.

The molten aluminum subjected to such processes is then supplied to the casting step to produce the ingot.

The aluminum ingot is produced in a semi-continuous casting method in which the molten aluminum is poured into a water-cooled mold so that the molten aluminum in contact with the water-cooled mold is cooled and solidified to form a solidified shell, and then, while the solidified shell and the molten aluminum within the solidified shell are being drawn out from a lower portion of the water-cooled mold, the cooling water is directly jetted to a lower portion of the solidified shell so that the molten aluminum within the solidified shell is cooled and solidified.

Incidentally, the cooling process preformed inside the water-cooled mold is called a primary cooling, and the cooling process directly preformed on the solidified shell is called a second cooling.

At this time, since the water-cooled mold is made of aluminum alloy or copper, it is necessary to take measure to prevent seizure caused by the direct contact of the molten aluminum with the water-cooled mold. The typical measure taken to prevent seizure is applying a lubricant to the inner surface of the water-cooled mold while the casting is being performed.

However, in conventional casting methods, no adequate measure is taken to remove the oxides generated after the filtering process (the filtration step), particularly the oxides on the surface of the molten aluminum generated inside the water-cooled mold.

For example, when the casting step is started, since the molten aluminum is poured from a trough into the water-cooled mold first, a large amount of the oxides is generated while the molten aluminum is being poured into the water-cooled mold. Also, even when the casting step enters a steady state after casting-starting time, there is a concern that the oxides generated on the surface of the molten aluminum inside the water-cooled mold will collect, and the collected oxides will enter the surface layer of the aluminum alloy and form a recessed portion in such a part.

Thus, not only the portion of the ingot formed at the casting-starting time, i.e., the lowermost portion, has to be cut and removed, but also the portion of the ingot formed in the steady state has to be subjected to a facing process so that the surface thereof is scraped more than required.

The problems caused by the oxides will become particularly serious if the alloy contains a high concentration of Mg.

To solve these problems, it is proposed that the molten aluminum is previously treated with chlorine (Cl) gas, sulfur hexafluoride (SF₆) gas or the like to inhibit the oxidation of the surface of the molten aluminum (see Japanese Patent Publication No. S63-48935, the detail description thereof is omitted herein). However, since such a method is performed in an in-line refining process, it has no adequate effect on inhibiting the oxidation of the oxidation of the surface of the molten aluminum inside the mold.

Further, since Cl is a poisonous substance, it not only causes environmental problem, but also seriously increases the deterioration of the peripheral devices.

On the other hand, since SF₆ has a high global warming potential up to 20000, it is not preferred to be used from the viewpoint of global warming prevention.

Further, SF₆ reacts chemically with hydrogen gas contained in the molten aluminum in the dehydrogenation step, in which a SNIF (Spinning Nozzle Inert Floatation) or a porous plug is used, to generate hydrogen fluoride (HF). Since HF is a strong corrosive substance, the furnace will be damaged. Also, the HF has very strong toxicity to living bodies.

To solve the problems, it is proposed that a protective gas mainly containing carbon dioxide gas (CO₂) is used as the gas to inhibit the oxidation. However, if a large amount of CO₂ is used, a part of CO₂ will be reduced in the molten aluminum to generate carbon monoxide, oxygen, carbon and the like, and therefore the oxidation and carbonization of the surface of the molten aluminum will be increased, so that inclusions such as oxides and carbides will be formed.

Besides, if the aluminum ingot is produced by the conventional production method, there is a concern that a coarse cells layer or a coarse structure called “sub-surface band” will be generated on the surface of the ingot. The coarse structure is generated because the solidified shell formed inside the water-cooled mold is solidified and contracted, and the contracted solidified shell is a little apart from the mold so that an air gap is formed, by which the heat conduction is insulated and therefore the cooling speed is slowed down.

Since the existence of the coarse structure can be the cause of the surface flaw and cracking of the end-product, the ingot has to be subjected to an excessive facing process to remove the coarse structure if a high-grade ingot is required.

There are several proposals to solve this problem.

One of the proposals is to cast the ingot using electromagnetic field. The method of casting the ingot using electromagnetic field is a method of holding the molten aluminum in a predetermined shape by an electromagnetic force. With such a method, since there is no primary cooling as in the water-cooled mold, the ingot can be produced without forming the coarse structure. However, because of high cost (since the electricity is used) and very difficult control, such a method has not been put into practical use yet.

Another one of the proposals is to use graphite to form at least a part of the inner wall of the water-cooled mold in contact with the molten aluminum. Compared with a conventional mold made of aluminum alloy or copper alloy, seizure unlikely occurs due to self-lubrication and self-consumption in the case where the mold having a graphite-made inner wall is used, the amount (the thickness) of the lubricant (which will be discussed later) applied to the mold can be reduced. Thus, not only the contact condition between the molten aluminum and the mold can be improved but also the cooling effect can be improved, so that the coarse structure formed during the casting process of the aluminum ingot can be restrained, and therefore the forming of the air gap can be restrained.

Further another one of the proposals is, for example, employing a hot top method. The hot top method is a method in which a refractory vessel having substantially the same shape as the mold is arranged on an upper portion of the mold, and the casting process is performed while the molten aluminum is reserved in the refractory vessel. The mold made of graphite is generally used in such a method. With such a method, a pressure caused by the molten aluminum inside the refractory vessel is applied to the inside of the mold. In other words, since the molten aluminum is forcibly pressured toward the mold, the air gas is difficult to form, and therefore an excellent effect of restraining the forming of the coarse structure can be expected in the case where an aluminum round bar having a small diameter is produced, and the method has already put into practical use to produce the aluminum round bar having a small diameter.

However, if such a method is used to produce a large ingot, since there is a concern that the molten aluminum might leak out, the method has not been put into practical use. Thus, in the case of a large ingot, the ingot is produced by the aforesaid method in which the graphite is used to form a part of the inner wall of the water-cooled mold in contact with the molten aluminum.

However, because of significant oxidative consumption, the graphite needs to be changed frequently, such as after one-day use.

To solve this problem, it is proposed that the graphite is impregnated with the lubricant or that the lubricant is constantly supplied to the graphite.

However, in the case where the method in which the graphite is impregnated with the lubricant is used, since the impregnated lubricant is constantly burned due to the heat of the molten aluminum, the effect of restraining the oxidative consumption of the graphite can not be adequately achieved.

While in the case where the method of constantly supplying the lubricant to the graphite is used, the excess lubricant will be mixed into the cooling water used for forming the solidified shell. Since the cooling water is usually used in a circulating manner, if the lubricant is mixed into the cooling water, a large amount of bacteria and algae will thrive in a cooling water circuit and a water tank with the lubricant as nutrient source, and therefore the cooling water circuit might be clogged. Further, it will take a high cost to separate the lubricant from the water when changing and disposing the cooling water.

Further, in the case where the graphite is used to form the inner wall of the water-cooled mold, since the oxides generated on the surface of the molten aluminum can not be restrained, the problems concerning the oxides can not be solved. Thus, it is difficult to reduce the facing process amount or totally eliminate the facing process itself.

Thus, it is desirable to provide a method for producing aluminum ingot in which not only the amount of the oxides generated on the surface of the molten aluminum can be restrained but also the oxidative consumption of the graphite on the inner wall of the water-cooled mold can be restrained, to provide an aluminum ingot produced using such a method, and to provide a preferred protective gas for obtaining such an aluminum ingot.

### DISCLOSURE OF THE INVENTION

In other words, an object of the present invention is to provide a method for producing aluminum ingot described below, an aluminum ingot produced using such a method, and a preferred protective gas for obtaining such an aluminum ingot.

[1] A method for producing an aluminum ingot of aluminum or aluminum alloy includes: a melting step of melting an aluminum base metal into a molten aluminum; a holding step of holding the resulting molten aluminum; a dehydrogenation step of removing hydrogen gas from the molten aluminum; a filtration step of removing inclusions from the molten aluminum; and a casting step of solidifying the molten aluminum into a predetermined shape with a water-cooled mold, wherein at least one of the above steps is conducted in the atmosphere of a protective gas containing a fluorinating gas.

In each of the above steps of the method for producing the aluminum ingot according to the present invention, since the melting process, the holding process, the dehydrogenation process, the inclusions removing process and the solidifying process are performed in the atmosphere of the protective gas for restraining oxidation of the molten aluminum, the protective gas containing fluorinating gas, the generation of the oxides on the surface of the molten aluminum can be restrained.

[2] It is preferred that the protective gas contains 0.001-1 mass % fluorinating gas, 0.01-10 mass % carbon dioxide gas, and the balance which includes at least one of nitrogen gas and argon gas; and

[3] It is preferred that the fluorinating gas is a fluorinated ketone.

With such a method for producing the aluminum ingot, since main components of the protective gas are nitrogen gas and/or argon gas, the surface of the molten aluminum can be prevented from being oxidized. Incidentally, compared with the conventional protective gas whose main component is carbon dioxide gas, the aforesaid protective gas contains relatively less carbon gas, and therefore the aluminum or aluminum alloy can be prevented from being oxidized and at the same time, carbonization can be reduced.

Particularly, with the method for producing the aluminum ingot according to the present invention, since an AlF₃ film can be formed on the surface of the molten aluminum by using the fluorinated ketone (as the fluorinating gas), the oxidation of the surface of the molten aluminum can be further prevented.

[4] It is preferred that, in the method for producing the aluminum ingot according to the present invention, at least a part of an inner wall of the water-cooled mold in contact with the molten aluminum is formed by graphite or a material containing graphite.

In this manner, since at least a part of the inner wall of the water-cooled mold in contact with the molten aluminum is formed by graphite or the material containing graphite, the molten aluminum can be prevented from being oxidized. Thus, the generation of the oxidation can be further restrained.

Further, with the method for producing the aluminum ingot according to the present invention, since the casting step is performed in the atmosphere of the protective gas, oxidative consumption of the graphite can be restrained, and therefore graphite can be maintained in a good condition. Thus, not only the generation of the oxides of the ingot to be cast can be prevented, but also the generation of the coarse structure of the ingot can be prevented, and therefore an air gap can be prevented from being formed.

[5] It is preferred that, in the casting step of the method for producing the aluminum ingot according to the present invention, no casting lubricant is used for forming the molten aluminum into a predetermined shape.

Since no lubricant is used for performing the casting step, there is no concern that the lubricant will be mixed into the circulating cooling water, and therefore bacteria and algae can be prevented from growing. Thus, not only the cooling water circuit can be prevented from being clogged, but also no high cost needs be taken to separate the lubricant from the water when changing and disposing the cooling water.

[6] It is preferred that, in the case where the aluminum alloy base metal is used in the method for producing the aluminum ingot according to the present invention, the aluminum alloy contains 7-40 mass % magnesium.

With the method for producing the aluminum ingot according to the present invention, since the casting step and the like are performed in the atmosphere of the protective gas containing fluorinating gas, even if the aluminum alloy contains high concentration of magnesium, which is an active metal, the aluminum ingot can be produced without generating the oxides on the surface of the molten aluminum.

[7] An aluminum ingot of aluminum or aluminum alloy according to the present invention contains 10 ppm or lower Al₂O₃ and MgAl₂O₄, and 4 ppm or lower Al₄C₃ and Al₂C₆.

[8] At this time, aluminum ingot according to the present invention may contain 7-40 mass % magnesium.

Since the aluminum ingot according to the present invention contains less oxides (such as Al₂O₃ and MgAl₂O₄) and less carbides (such as Al₄C₃ and Al₂C₆), it will be difficult to cause surface flaw and cracking when manufacturing, for example, aluminum sheet (such as can material and disc material) from such an aluminum ingot.

Particularly, even if the aluminum alloy contains high concentration of magnesium, which is an active metal, the aluminum ingot containing substantially no oxides and carbides can be produced.

[9] A protective gas according to the present invention contains 0.001-1 mass % fluorinating gas, 0.01-10 mass % carbon dioxide gas, and the balance which includes at least one of nitrogen gas and argon gas.

By using such a protective gas for producing the aluminum ingot, since main components of the protective gas are nitrogen gas and/or argon gas, the surface of the molten aluminum can be prevented from being oxidized. Further, compared with the conventional protective gas whose main component is carbon dioxide gas, the above-mentioned protective gas for producing the aluminum ingot contains relatively less carbon gas, and therefore the aluminum or aluminum alloy not only can be prevented from being oxidized but also can be prevented from being carbonized.

With the present invention, the following effects can be achieved.

With the method for producing the aluminum ingot of the present invention, since the surface of the molten aluminum can be prevented from being oxidized, the aluminum ingot containing substantially no aggregate (dross) of the oxides and no coarse structure can be produced.

Further, since the aluminum ingot produced by using the method for producing aluminum ingot contains substantially no dross, the facing process amount can be reduced, or even the facing process can be totally eliminated. Further, since the aluminum ingot contains substantially no coarse structure, the generation of the surface flaw and cracking of the end-product manufactured from the aluminum ingot can be restrained.

Further, since the aluminum ingot of the present invention contains substantially no oxides (including dross) and coarse structure, the generation of the surface flaw and cracking of the end-product manufactured from the aluminum ingot can be re-strained.

Each of the aspects of the present invention and the effects thereof, as well as other effects and further characters, will become clearer by detail description of the below exemplary and nonrestrictive embodiments, with reference to the attached drawings.

### BRIEF DESCRIPTION OF DRAWINGS

FIG. 1 is a view briefly explaining processes from melting an aluminum base metal to producing an aluminum ingot;

FIGS. 2A to 2C are views each explaining a protective gas supply means; and

FIGS. 3A to 3C are views each explaining a protective gas supply means.

### BEST MODE FOR CARRYING OUT THE INVENTION

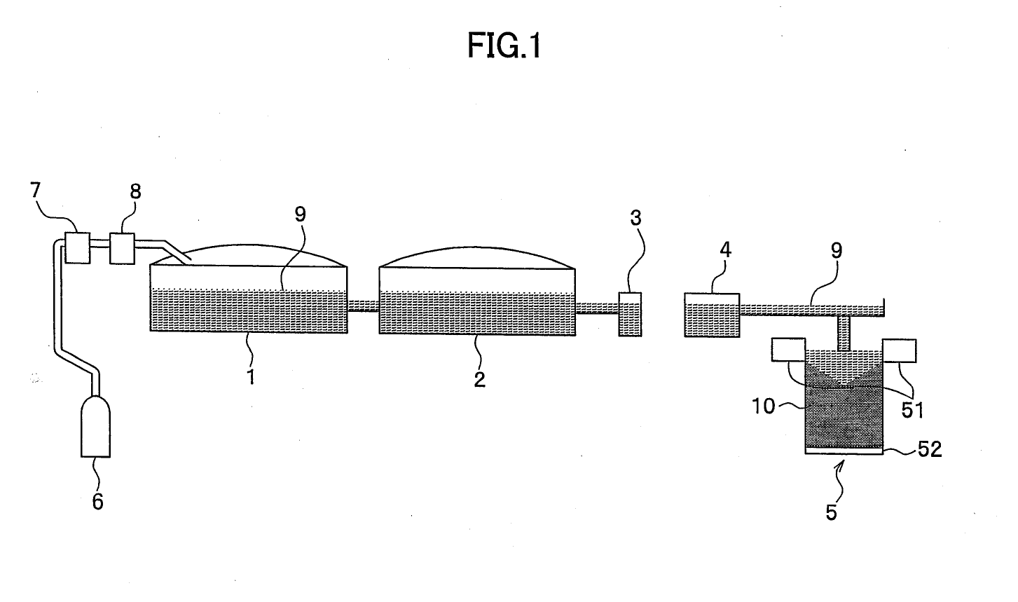

A method for producing aluminum ingot according to the present invention, an aluminum ingot produced using such a method, and a preferred protective gas for obtaining such an aluminum ingot will be described below with reference to FIG. 1.

Incidentally, FIG. 1 is a view briefly explaining processes from melting an aluminum base metal to producing an aluminum ingot.

As shown in FIG. 1, the method for producing aluminum ingot according to the present invention can be applied to any of the steps from the step of melting an aluminum base metal or aluminum alloy base metal to the step of casting an aluminum ingot 10. Incidentally, the detail about the aluminum base metal or aluminum alloy base metal will be discussed later.

Specifically, among the melting step, the holding step, the dehydrogenation step, the filtration step and the casting step, at least one step is performed in the atmosphere of a protective gas containing fluorinating gas, carbon dioxide gas, and nitrogen and/or argon gas.

Incidentally, although the method for producing aluminum ingot according to the present invention is most preferably applied to all above steps, the excellent anti-oxidizing effect of the method is particularly achieved when the method is applied to the dehydrogenation step and/or filtration step immediately before the step of casting the aluminum ingot 10.

The melting step is a step for melting, in a melting furnace 1 shown in FIG. 1, the aluminum base metal or aluminum alloy base metal into the molten aluminum 9.

At this time, the temperature of the molten aluminum 9 inside the melting furnace 1 is about 750 to 800° C. Generally, when the temperature exceeds 750° C., the surface of the molten aluminum 9 will be easily oxidized so as to generate the oxides. However, by using a below-described protective gas to protect the surface of the molten aluminum 9 (hereinafter referred to as “in the atmosphere of protective gas”), the surface of the molten aluminum 9 can be prevented from being oxidized.

The holding step is a step for temporarily holding the molten aluminum 9 in a holding furnace 2 shown in FIG. 1 to add components such as magnesium (Mg) according to necessity, make final checks, and adjust the temperature into the most suitable temperature for producing the aluminum ingot 10.

The temperature of the molten aluminum 9 at this time is kept to a level substantially identical to that of the molten aluminum 9 in the melting step. Thus, in the holding step, the surface of the molten aluminum 9 is also apt to be oxidized. Thus, by holding the molten aluminum 9 in the atmosphere of the protective gas of the present invention, the surface of the molten aluminum 9 can be prevented from being oxidized. Although a large amount of oxides will be generated when Mg and the like is added in the present step, since the base metal has already been melted at this time and therefore needs not to be excessively heated with a burner or the like, the surrounding air will be less disturbed, so that the protective gas can be effectively applied.

The dehydrogenation step is a step for removing hydrogen gas in the molten aluminum 9 in a dehydrogenation unit 3 shown in FIG. 1.

Hydrogen gas is mainly generated from the hydrogen contained in the fuel, from the water adhered on the aluminum base metal, and from the organic materials. If much hydrogen gas is contained, pinholes will be caused when rolling the aluminum ingot 10, which will lower the strength of the product. Further, if there is much hydrogen gas, blister will be formed on the surface when rolling the aluminum ingot 10. Thus, it is necessary to lower the hydrogen gas to a level of less than 0.15 ml per 100 g, preferably less than 0.1 ml per 100 g of the molten aluminum.

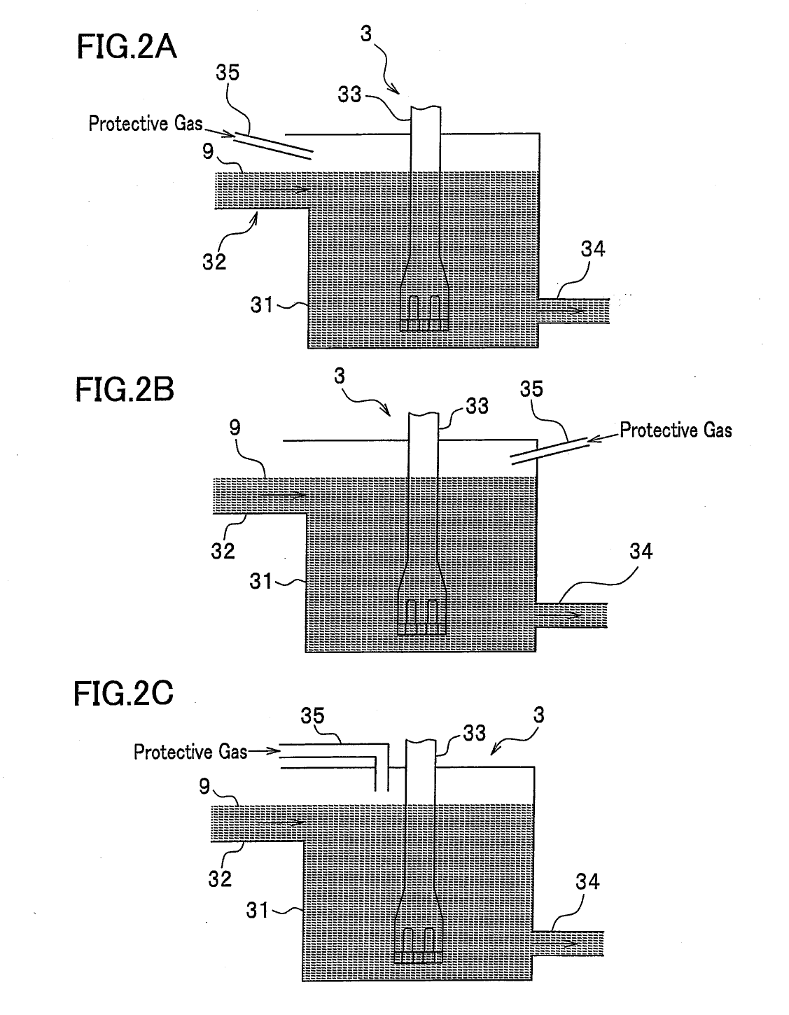

Although the hydrogen gas in the dehydrogenation step can be preferably removed by performing fluxing, chlorine refining, in-line refining or the like at the aforesaid temperature, the hydrogen gas can be more preferably removed by using a SNIF (see FIG. 2) or a porous plug in the dehydrogenation unit 3 (see JP2002-146447A).

Also, similar to the other steps mentioned above, the dehydrogenation step also can be performed in the atmosphere of the protective gas of the present invention so that the surface of the molten aluminum 9 can be prevented from being oxidized.

The filtration step is a step for removing inclusions mainly including oxides and nonmetallic substances in a filter 4 shown in FIG. 1.

The filter 4 is provided with ceramic tubes (not shown) made of alumina particles each with a diameter of about 1 mm. The molten aluminum 9 passes though the ceramic tubes so that the oxides and inclusions can be removed.

Further, if the protective gas is used after the filtration step, the oxides can be restrained from being generated, and the resulting molten aluminum, of which the quality is highly improved by performing dehydrogenating and filtering processes, can be used in its entirety to cast the aluminum ingot 10. Further, since the dross of the oxides can be restrained, the labor for removing the dross can be reduced.

The casting step is a step for producing the aluminum ingot 10 by solidifying the molten aluminum 9 into a predetermined shape (such as a rectangular parallelepiped shape).

For example, the aluminum ingot is produced in a semi-continuous casting method in which the molten aluminum 9 is poured into a water-cooled mold 51, the cooling water is jetted against the molten aluminum 9 in contact with the water-cooled mold 51 so that the molten aluminum 9 is cooled and solidified to form a solidified shell, and further, while the solidified shell and the molten aluminum within the solidified shell are being drawn out by a holder 52 from a lower portion of the water-cooled mold 51, the cooling water is directly jetted toward a lower portion of the solidified shell so that the molten aluminum within the solidified shell is cooled and solidified.

By using the method for producing aluminum ingot of the present invention, the oxides can be prevented from being mixed into the aluminum ingot 10 even in the casting step, in which it was conventionally difficult to prevent the surface of the molten aluminum 9 from being oxidized. Incidentally, at least a part of the inside of the water-cooled mold 51 in contact with the molten aluminum (such as a part of the inner wall of the water-cooled mold 51) can be formed by graphite or substance containing graphite.

The protective gas, which prevents the surface of the molten aluminum 9 from being oxidized, used in all above steps contains fluorinating gas, carbon dioxide gas, and nitrogen and/or argon gas.

It is preferred that the protective gas contains 0.001-1 mass % fluorinating gas, 0.01-10 mass % carbon dioxide gas, and the balance which includes at least one of nitrogen gas and argon gas. However, the protective gas may include other gas as long as the effect of the present invention can be achieved. Examples of the other gas include inert gas arbitrarily contained and gas inevitably mixed thereinto. Examples of the inert gas include argon gas and helium gas, and examples of the gas inevitably mixed thereinto include oxygen gas.

By controlling the concentration of fluorinating gas of the protective gas in the above range, since the fluorinating gas reacts with the aluminum of the surface of the molten aluminum 9 to form an AlF₃ film, the molten aluminum 9 can be prevented from being oxidized.

On the other hand, if the concentration of fluorinating gas in the protective gas is less than the above range, since the AlF₃ film formed by reaction of the fluorinating gas with the aluminum of the surface of the molten aluminum 9 is inadequate, it is difficult to prevent the molten aluminum 9 from being oxidized. Further, if the concentration of fluorinating gas in the protective gas is higher than the above range, there is a concern that harmful substances such as COF₂ will be formed.

Incidentally, the reason of controlling the concentration of carbon dioxide gas in the above range will be discussed later.

Further, since the concentration of the nitrogen gas is high in the protective gas, not only the oxidation of the molten aluminum 9 can be prevented, but also the carbonization of the molten aluminum 9 can be prevented because of the reduced carbon source.

Incidentally, nitrogen gas will react with aluminum of the molten aluminum 9 to form aluminum nitride. The resulting aluminum nitride is formed by heating the aluminum carbide in the atmosphere of nitrogen gas. Thus, according to the present invention, since the concentration of carbon gas in the protective gas is reduced, the resulting aluminum carbide is reduced, and therefore such aluminum nitride is difficult to be formed. As a result, there is almost no aluminum nitride in the aluminum ingot 10.

Fluorinated ketone gas is preferred to be used as the fluorinating gas of the present invention. Perfluoroketone gas, hydrofluoroketone gas, or a mixture of the both gases is particularly preferred to be used.

Since the fluorinated ketone is usually liquid at normal temperature, it has to be vaporized in order to be used as the protective gas.

In order to obtain the vaporized protective gas, a liquefied master gas is prepared by feeding a predetermined amount (0.01-10 mass %, preferably 0.1-2 mass %) of the liquid fluorinated ketone into a pressure tank 6 shown in FIG. 1 and then feeding a liquefied carbon dioxide so that the balance is carbon gas. Thereby the fluorinated ketone can be uniformly dispersed in the liquefied carbon dioxide gas. Incidentally, the carbon gas becomes a supercritical liquid in the pressure tank, and uniformly disperses the fluorinated ketone therein. Within the range where supercritical effect exists, the nitrogen gas, the argon gas and the other gases can be mixed without causing any problem.

Further, the liquefied master gas including the fluorinated ketone and liquefied carbon dioxide gas contained in the pressure tank 6 is heated not exceeding 40° C. so that the liquefied master gas becomes master gas. Further, the master gas and nitrogen gas are mixed in a mixing ratio of for example 1:9, so that a protective gas is obtained which contains 0.001-1 mass % fluorinating gas, 0.01-10 mass % carbon dioxide gas, and the balance which includes nitrogen gas. Incidentally, the nitrogen gas can be replaced by other inert gas such as argon gas, and further, the nitrogen gas can be replaced by a mixture of nitrogen gas and argon gas.

The protective gas obtained in such a manner is continuously or intermittently supplied to the melting furnace 1 while being monitored with a flowmeter 8, so that the surface of the molten aluminum 9 can be prevented from being oxidized.

The molecular weight of the fluorinated ketone is preferably 250 or higher, more preferably 300 or higher. By adopting the fluorinated ketone having the molecular weight in the aforesaid range, the fluorinated ketone can easily disperse in the liquefied carbon dioxide gas uniformly. Incidentally, it is preferred that the number of carbonyl groups contained in the fluorinated ketone of one molecule is 1.

It is preferred that the carbon number of the perfluoroketone is 5-9. It is preferred that the perfluoroketone includes at least one member selected from the group of: CF₃CF₂C(O)CF(CF₃)₂, (CF₃)₂CFC(O)CF(CF₃)₂, CF₃(CF₂)₂C(O)CF(CF₃)₂, CF₃(CF₂)₃C(O)CF(CF₃)₂, CF₃(CF₂)₅C(O)CF₃, CF₃CF₂C(O)CF₂CF₂CF₃, CF₃C(O)CF(CF₃)₂, and perfluorocyclohexanone. In other words, the perfluoroketone can be one member selected from the group, or can be a mixture of two or more members selected from the group.

It is preferred that the carbon number of the hydrofluoroketone is 4-7.

It is preferred that the hydrofluoroketone includes at least one member selected from the group of: HCF₂CF₂C(O)CF(CF₃)₂, CF₃C(O)CH₂C(O)CF₃, C₂H₅C(O)CF(CF₃)₂, CF₂CF₂C(O)CH₃, (CF₃)₂CFC(O)CH₃, CF₃CF₂C(O)CHF₂, CF₃CF₂C(O)CH₂F, CF₃CF₂C(O)CH₂CF₃, CF₃CF₂C(O)CH₂CH₃, CF₃CF₂C(O)CH₂CHF₂, CF₃CF₂C(O)CH₂CHF₂, CF₃CF₂C(O)CH₂CH₂F, CF₃CF₂C(O)CHFCH₃, CF₃CF₂C(O)CHFCHF₂, CF₃CF₂C(O)CHFCH₂F, CF₃CF₂C(O)CF₂CH₃, CF₃CF₂C(O)CF₂CHF₂, CF₃CF₂C(O)CF₂CH₂F, (CF₃)₂CFC(O)CHF₂, (CF₃)₂CFC(O)CH₂F, CF₃CF (CH₂F) C(O)CHF₂, CF₃CF (CH₂F) C(O)CH₂F, and CF₃CF (CH₂F) C(O)CF₃. In other words, the hydrofluoroketone can be one member selected from the group, or can be a mixture of two or more members selected from the group.

Among the above substances, it is particularly preferred that a pentafluoroethyl-heptafluoropropylketone, namely, a C₃F₇ (CO)C₂F₅ (for example, CF₃CF₂C(O)CF (CF₃)₂, CF₃CF₂C(O)CF₂CF₂CF₃) is used.

Compared with the conventional protective gas whose main component is carbon dioxide gas, the protective gas described above can not only prevent the surface of the molten aluminum from being oxidized, but also prevent the surface of the molten aluminum from being carbonized.

Further, since the protective gas produces less carbon monoxide and since the protective gas has low global warming potential, it is safe and less harmful to the environment.

Thus, with the method for producing the aluminum ingot using the protective gas of the present invention, since the molten aluminum (or molten aluminum alloy) 9 is processed in the atmosphere of the protective gas which contains the particular components, the aluminum ingot 10 containing almost no inclusions (such as oxides) can be produced.

Further, with the method of the present invention for casting the aluminum ingot in the atmosphere of the protective gas, since no graphite is consumed, lubricant is not necessary to use. Thus, the cooling water circuit can be prevented from being clogged, and the cooling water can be easily disposed.

Incidentally, it is preferred that the protective gas of the present invention is not only used to protect the surface of the molten aluminum 9 inside the furnaces or devices used in the melting step, the holding step, the dehydrogenation step, the filtration step, and the casting step, but also applied to a trough (not shown) for carrying the molten aluminum 9.

Specifically, when carrying the molten aluminum 9, the protective gas of the present invention is previously fed into the trough and then the molten aluminum 9 is poured into the trough, and therefore the surface of the molten aluminum 9 can be protected, so that the surface of the molten aluminum 9 can be prevented from being oxidized.

As described above, with the method for producing aluminum ingot of the present invention, the surface of the molten aluminum 9 can be prevented from being oxidized, so that the aluminum ingot 10 containing substantially no oxides can be produced.

More specifically, by employing the method for the producing aluminum ingot of the present invention, the aluminum ingot 10 can be produced not only from a 1000 series pure aluminum specified in JISH4000 but also from a 5000 series aluminum alloy (whose Mg concentration is approximately 0.5-5.5 mass %) specified in JISH4000 which contains high concentration of magnesium.

Further, by employing the method for producing aluminum ingot of the present invention, the aluminum ingot 10 can be preferably produced even from an aluminum alloy containing further higher concentration of magnesium.

Specifically, the aluminum ingot 10 containing 10 ppm or lower oxides, such as Al₂O₃ and MgAl₂O₄, and 4 ppm or lower carbides, such as Al₄C₃ and Al₂C₆, can be produced even from an aluminum alloy whose magnesium concentration is higher than 6 mass %, preferably 7-40 mass %.

If the magnesium concentration exceeds 40 mass %, since the reactivity of the aluminum alloy is too high, the oxides will be easy to form, and that is undesirable.

If the oxides concentration exceeds 10 ppm, and/or the carbides concentration exceeds 4 ppm, there will be too much oxides and/or carbides, and that is undesirable.

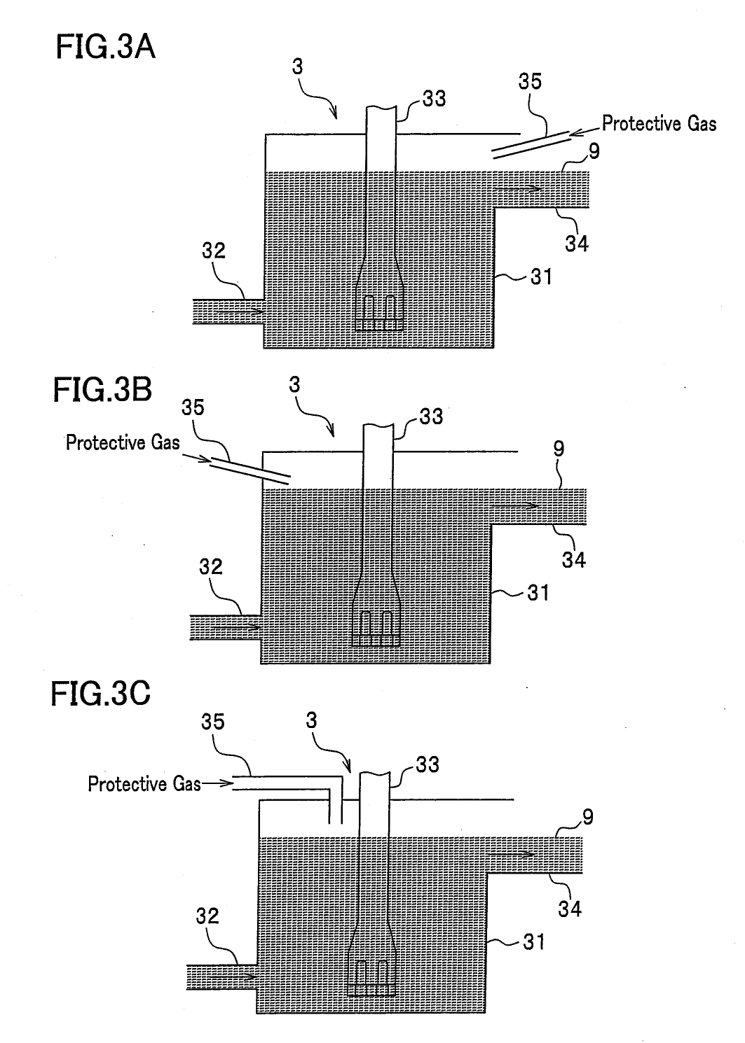

A protective gas supply means will be described below with reference to FIGS. 2A, 2B, 2C, 3A, 3B and 3C. FIGS. 2A to 2C and

FIGS. 3A to 3C are views each explaining a protective gas supply means.

As an example of supplying the protective gas, FIGS. 2A, 2B, 2C, 3A, 3B and 3C each explain a protective gas supply means provided in the dehydrogenation unit 3. However, the protective gas supply means obviously can be provided in the melting furnace 1, the holding furnace 2, the filter 4, the casting device 5 and the trough (not shown) in the same manner, instead of being limited to the dehydrogenation unit 3.

As shown in FIG. 2A, in the dehydrogenation unit 3, the molten aluminum (or molten aluminum alloy) 9 is fed from an inlet 32 provided in the upper portion of the side face of a container 31, the fed molten aluminum 9 is stirred by a stirring means 33 (such as a SNIF) so that the hydrogen gas contained in the molten aluminum 9 is removed. Further, the molten aluminum 9 from which hydrogen gas has removed is discharged from an outlet 34 provided in the lower portion of the side face facing the inlet 32.

As an example of the protective gas supply means in such a dehydrogenation unit 3, there is an arrangement in which a supply port 35 for supplying the protective gas is provided to the same side face as that of the inlet 32 of the container 31, as shown in FIG. 2A.

In the dehydrogenation unit 3 having such an arrangement, since the supply port 35 is provided inside the inlet 32, the oxidation of surface of the molten aluminum 9 can be prevented at an early stage. Further, since the supply port 35 faces the closed side of the container 31, the protective gas supplied to the container 31 is hardly discharged to the outside of the container 31. Thus, the protective gas concentration can be maintained at high level. Consequently, the surface of the molten aluminum 9 is less likely to be exposed to air, and therefore effect of preventing the surface of the molten aluminum 9 from being oxidized can be further improved.

As other examples of the protective gas supply means, there is an arrangement as shown in FIG. 2B in which the supply port 35 is provided to the same side face as that of the outlet 34; and an arrangement as shown in FIG. 2C in which the supply port 35 is provided near an upper central portion of the container 31. With such a protective gas supply means, the oxidation of surface of the molten aluminum 9 also can be effectively prevented.

Incidentally, as shown in FIGS. 3A to 3C, the supply port 35 even can be provided to a dehydrogenation unit 3 whose outlet 34 for discharging the molten aluminum 9 having hydrogen gas removed can contact with air in the same manner, so that the oxidation of surface of the molten aluminum 9 can be prevented.

As shown in FIGS. 2A and 3B, by arranging the protective gas supply port 35 of the protective gas on the same side of the inlet 32 of the molten aluminum 9, since the high oxidation preventing effect can be achieved at the time when the molten aluminum 9 is fed, the dross caused by oxides can be prevented.

Further, by arranging the supply port 35 of the protective gas on the same side of the outlet 34 of the molten aluminum 9 as shown in FIGS. 2B and 3A, the quality of the molten aluminum can be ensured and improved.

Further, the supply port 35 also can be provided near the upper central portion of the container 31 as shown in FIG. 3C. With such an arrangement, the oxidation of surface of the molten aluminum 9 also can be effectively prevented.

### EXAMPLES

In the following Examples 1 to 3, a detail review was conducted to the method for producing the aluminum ingot according to the present invention, the aluminum ingot produced by using such a method, and the preferred protective gas for performing such a method.

### Example 1

Test Nos. 1 to 13 were performed by properly combining: one of the protective gases selected from air (namely absence of protective gas), a comparison gas (namely the conventional protective gas) and an example gas; one of the aluminum alloys selected from an aluminum alloy containing 2 mass % Mg, an aluminum alloy containing 7 mass % Mg and an aluminum alloy containing 10 mass % Mg (expressed as Al-2% Mg, Al-7% Mg, Al-10% Mg in Table 1); the supply positions of protective gas; and the cases where a ventilation opening for protective gas and the like was provided and where a ventilation opening for protective gas and the like was not provided.

Incidentally, the comparison gas and the example gas were prepared by using the MG shield (trademark), as the master gas, made by Taiyo Nippon Sanso Corporation, the MG shield containing 1% fluorinated ketone and 99% carbon dioxide.

In other words, the comparison gas was prepared by mixing the MG shield with carbon dioxide gas to form a mixture of 0.1 mass % fluorinated ketone and about 100 mass % carbon dioxide gas.

The example gas was prepared by mixing the MG shield with nitrogen gas to form a mixture of 0.1 mass % fluorinated ketone, 1 mass % carbon dioxide gas and about 99 mass % nitrogen gas.

First, one of air, the comparison gas and the example gas was filled up in a container. The length of the container was 1.5 m. The container had an opening whose diameter was 0.9 m. The container had an upper space above the molten aluminum, the height of the upper space being 0.5 m.

Thereafter, the molten aluminum of one of the aluminum alloys (Test Nos. 1-13) indicated in Table 1 was poured into the container at 750° C. At this time, the air, the comparison gas and the example gas were all intermittently supplied for 2 minutes in a 10-minute cycle and at a flow rate of 10 L/min.

In such a condition, after 50 t molten aluminum was poured at a flow rate of 800 kg/min, it was confirmed whether or not there were inclusions (namely, oxides and carbides) generated on the surface of the molten aluminum.

Whether or not there were oxides generated was confirmed by taking a sample of the surface of the poured molten aluminum and solidifying the sample in such a state, and then cutting the sample in a vertical direction to confirm whether or not there were oxides by visual observation or with an EPMA (an electron beam probe micro analyzer, JSM-6340F, made by JEOL). The sample having coarse massive oxides generated was rated as “inferior” (indicated “X” in the table), the sample having thick oxides film and partly coarse massive oxides generated was rated as “good” (indicated “Δ” in the table), and the sample only having thin oxides film generated was rated as “excellent” (indicated “O” in the table).

Whether or not there were carbides generated was confirmed by taking a sample of the surface of the poured molten aluminum and solidifying the sample in a vessel and by performing a mercuric chloride cracked gas chromatography. The sample having carbides generated was rated as “inferior” (indicated “X” in the table), and the sample having no carbides generated was rated as “excellent” (indicated “O” in the table).

TABLE 1

| | | | | | Inclusions on | | |
|---|---|---|---|---|---|---|---|
| | | | Having Ventilation | | Surface of | | |
| | Protective | Supply Position of | Opening for Protective | Components of | Molten Aluminum | | |
| Test | Gas | Protective Gas | Gas, etc.? | Aluminum Alloy | Oxides | Carbides | Remarks |
| 1 | Air | Molten Aluminum Inlet Side | No | Al—5% Mg | X | ◯ | Comparisons |
| 2 | Air | Molten Aluminum Inlet Side | No | Al—7% Mg | X | ◯ | |
| 3 | Air | Molten Aluminum Inlet Side | No | Al—10% Mg | X | ◯ | |
| 4 | Comparison Gas | Molten Aluminum Inlet Side | No | Al—2% Mg | ◯ | X | |
| 5 | Comparison Gas | Molten Aluminum Inlet Side | No | Al—7% Mg | ◯ | X | |
| 6 | Comparison Gas | Molten Aluminum Inlet Side | No | Al—10% Mg | Δ | X | |
| 7 | Example Gas | Molten Aluminum Inlet Side | No | Al—2% Mg | ◯ | ◯ | Examples |
| 8 | Example Gas | Molten Aluminum Inlet Side | No | Al—7% Mg | ◯ | ◯ | |
| 9 | Example Gas | Molten Aluminum Inlet Side | No | Al—10% Mg | ◯ | ◯ | |
| 10 | Example Gas | Molten Aluminum Outlet Side | No | Al—7% Mg | ◯ | ◯ | |
| 11 | Example Gas | Central Portion | Yes | Al—7% Mg | Δ | ◯ | |
| 12 | Example Gas | Molten Aluminum Inlet Side | Yes | Al—5% Mg | ◯ | ◯ | |
| 13 | Example Gas | Molten Aluminum Outlet Side | Yes | Al—7% Mg | Δ | ◯ | |

In Test Nos. 1-3 (all are comparisons), since no protective gas was used (namely, the surface of the molten aluminum was exposed to air), much oxides are generated (indicated “X” in the table), good result was not obtained.

In Test Nos. 4-6 (all are comparisons), since comparison gas (a mixture of 0.1 mass % fluorinated ketone and about 100 mass % carbon dioxide gas) was used as the protective gas, less oxides were generated (indicated “O” or “Δ” in the table), and good result was obtained.

However, because of high concentration of carbon dioxide gas, carbides were generated on the surface of the molten aluminum (indicated “X” in the table), and therefore good result was not obtained.

In contrast, in Test Nos. 7-13 (all were examples) in which the example gas (a mixture of 0.1 mass % fluorinated ketone, 1 mass % carbon dioxide gas and about 99 mass % nitrogen gas) was used, less oxides were generated (indicated “O” or “Δ” in the table), no carbides were generated (indicated “O” in the table), and therefore good result was obtained.

Particularly, as shown in Test Nos. 7-10, in the case where no ventilation opening for protective gas and the like was provided, there was higher effect of preventing the oxides and carbides from generating, and therefore a better result was obtained.

### Example 2

100 kg aluminum base metal was melted in a small melting furnace for test purpose, then Mg was added so that a molten aluminum having components of Al-7% Mg was prepared. Then the oxides in such a molten aluminum were removed by performing refining and filtering. A glass cloth with meshes of 1 mm was used for performing the filtering.

Then the resulting molten aluminum was cast into an aluminum alloy ingot using a water-cooled mold for test purpose having size of 150 in thickness and 400 in width.

At this time, the protective gas for casting the aluminum ingot was changed corresponding to the conditions of Test Nos. 14-21 of Table 2 to rate the oxides concentration of the surface of the molten aluminum and the environmental burden.

Incidentally, the inner wall of the water-cooled mold of Example 2 was made of aluminum alloy. Further, a lubricant (canola oil) was timely supplied while casting the aluminum ingot.

The concentration of oxides on the surface of the aluminum ingot and the environmental burden were rated for Test Nos. 14-21.

The concentration of oxides on the surface of the aluminum ingot was measured by an iodine methanol method (namely an oxides extracting method). The concentration of oxides of 30 ppm or higher was rated as “not preferred” (indicated “X” in the table), the concentration of oxides between 10-30 ppm was rated as “slightly not preferred” (indicated “Δ” in the table), and the concentration of oxides of 10 ppm or lower was rated as “preferred” (indicated “O” in the table).

The environmental burden was rated as “not preferred” (indicated “X” in the table) if the gas was a global warming gas, and as “preferred” (indicated “O” in the table) if the gas was not a global warming gas.

The kinds of the protective gas of Test Nos. 14-21 and the evaluation results thereof are shown in Table 2.

TABLE 2

| | Protective | Concentration of Oxides on | Environmental | |
|---|---|---|---|---|
| Test | Gas | Surface of Aluminum Ingot | Burden | Remarks |
| 14 | None (Air) | 30 ppm or Higher (X) | ◯ | Comparisons |
| 15 | Sulfur Hexafluoride Gas | 10 ppm or Lower (◯) | X | |
| 16 | Chlorine Gas | 10 ppm or Lower (◯) | X | |
| 17 | Argon Gas | 10~30 ppm or (Δ) | ◯ | |
| 18 | Nitrogen Gas | 30 ppm or Higher (X) | ◯ | |
| 19 | Mixture of 100 ppm | 10~30 ppm or (Δ) | ◯ | |
| | Fluorinated Ketone and | | | |
| | about 100% Carbon Dioxide | | | |
| 20 | Mixture of 100 ppm | 10 ppm or Lower (◯) | ◯ | Examples |
| | Fluorinated Ketone, about 1% | | | |
| | Carbon Dioxide and about 99% Argon | | | |
| 21 | Mixture of 50 ppm | 10 ppm or Lower (◯) | ◯ | |
| | Fluorinated Ketone, about 0.5% | | | |
| | Carbon Dioxide and about 99.5% Nitrogen | | | |

As shown in Table 2, since Test Nos. 14-19 (see “comparisons” in the remarks column) did not satisfy the conditions of the present invention, the concentration of oxides on the surface of the aluminum ingot was rated as “not preferred” (indicated “X” in the table) or “slightly not preferred” (indicated “Δ” in the table), and the environmental burden was rated as “not preferred” (indicated “X” in the table).

On the other hand, since Test Nos. 20 and 21 (see “examples” in the remarks column) satisfied the conditions of the present invention, both the concentration of oxides on the surface of the aluminum ingot and the environmental burden were rated as “preferred” (indicated “O” in the table).

Specifically, in Test No. 14, since no protective gas was used (namely, the surface of the molten aluminum was exposed to air), the environmental burden were rated as “preferred” (indicated “O” in the table), but the concentration of oxides on the surface of the aluminum ingot was 30 ppm or higher and therefore was rated as “not preferred” (indicated “X” in the table).

Further, in Test Nos. 15 and 16, since sulfur hexafluoride gas and chlorine gas are respectively used, the concentration of oxides on the surface of the aluminum ingot was 10 ppm or lower and therefore was rated as “preferred” (indicated “O” in the table), but the environmental burden was rated as “not preferred” (indicated “X” in the table).

In Test No. 17, since argon gas was used, the environmental burden were rated as “preferred” (indicated “O” in the table), but the concentration of oxides on the surface of the aluminum ingot was 10-30 ppm and therefore was rated as “slightly not preferred” (indicated “Δ” in the table).

In Test No. 18, since nitrogen gas was used, the environmental burden were rated as “preferred” (indicated “O” in the table), but due to inadequate anti-oxidizing effect, the concentration of oxides on the surface of the aluminum ingot reached 30 ppm or higher and therefore was rated as “not preferred” (indicated “X” in the table).

In Test No. 19, since a mixture of 100 ppm fluorinated ketone and about 100% carbon dioxide was used, the environmental burden was rated as “preferred” (indicated “O” in the table), but the concentration of oxides on the surface of the aluminum ingot was 10-30 ppm and therefore was rated as “slightly not preferred” (indicated “Δ” in the table). This result is because of the existence of the oxygen gas (active oxygen) generated by reducing the carbon dioxide of high concentration.

It is known that, from the result of Example 2, by using a protective gas containing fluorinated ketone and a high concentration of nitrogen gas (as an inert gas) to perform the method for producing aluminum ingot of the present invention, the concentration of oxides on the surface of the aluminum ingot can be reduced without increasing the environmental burden, namely, the oxides (including the dross) generated on the surface of the molten aluminum can be restrained.

### Example 3

In Example 3, 100 kg aluminum base metal was melted in a small melting furnace for test purpose, then Mg was added so that a molten aluminum having components of Al-5% Mg was prepared. Then the oxides in such a molten aluminum were removed by performing refining and filtering. A glass cloth with meshes of 1 mm was used for performing the filtering.

Then the resulting molten aluminum was cast into an aluminum alloy ingot using a water-cooled mold for test purpose having size of 150 in thickness and 400 in width.

At this time, the protective gas for casting the aluminum ingot was changed corresponding to the conditions of Test Nos. 22-28 of Table 3 to rate the oxides concentration of the surface of the molten aluminum and the environmental burden.

Incidentally, the inner wall of the water-cooled mold of Example 3 was made of graphite. Further, no lubricant was supplied while casting the aluminum ingot.

Not only the concentration of oxides on the surface of the aluminum ingot and the environmental burden were rated as in Example 2, but also graphite consumption was rated.

The concentration of oxides on the surface of the aluminum ingot and the environmental burden were rated in the same manner as in Example 2.

The graphite consumption should be rated as “preferred” (indicated “O” in the table) if it could be used for performing 10 or more times of casting, and rated as “not preferred” (indicated “X” in the table) if it could be used for less than 10 times of casting.

The kinds of the protective gas of Test Nos. 22-28 and the evaluation results thereof are shown in Table 3.

TABLE 3

| | Protective | Concentration of Oxides on | Graphite | Environmental | |
|---|---|---|---|---|---|
| Test | Gas | Surface of Aluminum Ingot | Consumption | Burden | Remarks |
| 22 | Sulfur Hexafluoride Gas | ◯ | ◯ | X | Comparisons |
| 23 | Chlorine Gas | ◯ | X | X | |
| 24 | Argon Gas | Δ | X | ◯ | |
| 25 | Nitrogen Gas | X | X | ◯ | |
| 26 | None (Air) | X | X | ◯ | |
| 27 | Mixture of 50 ppm | Δ | ◯ | ◯ | |
| | Fluorinated Ketone and | | | | |
| | about 100% Carbon Dioxide | | | | |
| 28 | Mixture of 100 ppm | ◯ | ◯ | ◯ | Present |
| | Fluorinated Ketone, about | | | | Invention |
| | 1% Carbon Dioxide and | | | | |
| | about 99% Nitrogen | | | | |

As shown in Table 3, since Test Nos. 22-27 (see “comparisons” in the remarks column) did not satisfy the conditions of the present invention, the concentration of oxides on the surface of the aluminum ingot was rated as “not preferred” (indicated “X” in the table) or “slightly not preferred” (indicated “Δ” in the table), and either the environmental burden or the graphite consumption was rated as “not preferred” (indicated “X” in the table).

On the other hand, since Test No. 28 (see “example” in the remarks column) satisfied the conditions of the present invention, all of the concentration of oxides on the surface of the aluminum ingot, the environmental burden and the graphite consumption were rated as “preferred” (indicated “O” in the table).

Specifically, in Test Nos. 22 and 23, since sulfur hexafluoride gas and chlorine gas are respectively used, the concentration of oxides on the surface of the aluminum ingot was 10 ppm or lower and therefore was rated as “preferred” (indicated “O” in the table), and the graphite consumption was also rated as “preferred” (indicated “O” in the table). However, the environmental burden was rated as “not preferred” (indicated “X” in the table).

In Test No. 24, since argon gas was used, the environmental burden was rated as “preferred” (indicated “O” in the table), but the concentration of oxides on the surface of the aluminum ingot was 10-30 ppm and therefore was rated as “slightly not preferred” (indicated “Δ” in the table). Further, the graphite consumption was rated as “not preferred” (indicated “X” in the table).

In Test No. 25, since nitrogen gas was used, the environmental burden was rated as “preferred” (indicated “O” in the table), but, due to inadequate anti-oxidizing effect, the concentration of oxides on the surface of the aluminum ingot was 30 ppm or higher and therefore was rated as “not preferred” (indicated “X” in the table). Also, the graphite consumption was rated as “not preferred” (indicated “X” in the table).

In Test No. 26, since no protective gas was used (namely, the surface of the molten aluminum was exposed to air), the environmental burden were rated as “preferred” (indicated “O” in the table), but the concentration of oxides on the surface of the aluminum ingot was 30 ppm or higher and therefore was rated as “not preferred” (indicated “X” in the table).

In Test No. 27, since a mixture of 100 ppm fluorinated ketone and about 100% carbon dioxide was used, both the environmental burden and the graphite consumption were rated as “preferred” (indicated “O” in the table), but the concentration of oxides on the surface of the aluminum ingot was 10-30 ppm and therefore was rated as “slightly not preferred” (indicated “Δ” in the table). This result is because of the existence of the oxygen gas (active oxygen) generated by reduction of the carbon dioxide of a high concentration.

It is known that, from the result of Example 3, by using a protective gas containing fluorinated ketone and a high concentration of nitrogen gas (as inert gas) to perform the method for producing aluminum ingot of the present invention, the concentration of oxides on the surface of the aluminum ingot can be reduced without increasing the environmental burden, namely, the oxides (including the dross) generated on the surface of the molten aluminum can be restrained. Further, it is known that, by employing the method for producing the aluminum ingot using the aforesaid protective gas, even in the case where graphite is used in the water-cooled mold, the graphite consumption can be restrained.

1. A method for producing an aluminum ingot of aluminum or aluminum alloy, the method comprising:
a melting step of melting an aluminum base metal into a molten aluminum;
a holding step of holding the resulting molten aluminum;
a dehydrogenation step of removing hydrogen gas from the molten aluminum;
a filtration step of removing inclusions from the molten aluminum; and
a casting step of solidifying the molten aluminum into a predetermined shape with a water-cooled mold,
wherein at least one of the above steps is conducted in the atmosphere of a protective gas containing a fluorinating gas.

2. The method for producing the aluminum ingot according to claim 1, wherein the protective gas contains 0.001-1 mass % fluorinating gas, 0.01-10 mass % carbon dioxide gas, and the balance which includes at least one of nitrogen gas and argon gas.

3. The method for producing the aluminum ingot according to claim 1, wherein the fluorinating gas is a fluorinated ketone.

4. The method for producing the aluminum ingot according to claim 1, wherein at least a part of an inner wall of the water-cooled mold in contact with the molten aluminum is formed of graphite or a material containing graphite.

5. The method for producing the aluminum ingot according to claim 1, wherein in the casting step, no casting lubricant is used for forming the molten aluminum into a predetermined shape.

6. The method for producing the aluminum ingot according to claim 1, wherein the aluminum alloy contains 7-40 mass % magnesium.

7. An aluminum ingot of aluminum or an aluminum alloy, containing 10 ppm or lower Al₂O₃ and MgAl₂O₄, and 4 ppm or lower Al₄C₃ and Al₂C₆.

8. An aluminum ingot containing 7-40 mass % magnesium.

9. A protective gas containing 0.001-1 mass % fluorinating gas, 0.01-10 mass % carbon dioxide gas, and the balance which includes at least one of nitrogen gas and argon gas.

10. The method for producing the aluminum ingot according to claim 2, wherein the fluorinating gas is a fluorinated ketone.

11. The method for producing the aluminum ingot according to claim 2, wherein the aluminum alloy contains 7-40 mass % magnesium.

12. The method for producing the aluminum ingot according to claim 3, wherein the aluminum alloy contains 7-40 mass % magnesium.

13. The method for producing the aluminum ingot according to claim 4, wherein the aluminum alloy contains 7-40 mass % magnesium.

14. The method for producing the aluminum ingot according to claim 5, wherein the aluminum alloy contains 7-40 mass % magnesium.

15. The method for producing the aluminum ingot according to claim 10, wherein the aluminum alloy contains 7-40 mass % magnesium.
